(19) United States
(12) Patent Application Publication
(10) Pub. No.: US 2026/0133149 A1
(43) Pub. Date: May 14, 2026

(54) LAYER SEPARATION FOR E-BEAM OVERLAY METROLOGY

(71) Applicant: Applied Materials Israel Ltd., Rehovot (IL)

(72) Inventors: Sankalp VERMA, Bengaluru (IN); Ganesh Kumar MOHANUR RAGHUNATHAN, Bengaluru (IN); Balaji CHITHUGNANAMOORTHY, Bangalore (IN)

(21) Appl. No.: 18/945,424

(22) Filed: Nov. 12, 2024

(51) Int. Cl. G01N 23/2252

(52) U.S. Cl. CPC G01N 23/2252; G01N 2223/079; G01N 2223/401

(57) ABSTRACT

A computerized system for layer separation for e-beam overlay metrology that includes a processing and memory circuitry (PMC) configured to generate an X-ray image from an upper layer signal component and a lower layer signal component of an X-ray signal that is detected by an X-ray detector and is generated in response to illuminating a wafer with an e-beam. the wafer includes an upper layer composed of a first material and a lower layer composed of a different material. The upper layer includes a plurality of first patterns and the lower layer includes a plurality of second patterns, wherein at least a few of the second patterns are partially or fully occluded by a few of the first patterns. The upper layer signal component and the lower-layer signal component represents the patterns in the upper and lower layers respectively, and wherein the upper layer and lower layer signal components are segregable by unique wavelengths that depend on their respective first and second materials.

### TECHNICAL FIELD

The presently disclosed subject matter relates, in general, to the field of layer separation for e-beam overlay metrology.

### BACKGROUND

Current demands for high density and performance, associated with ultra large-scale integration of fabricated devices, require submicron features, increased transistor and circuit speeds, and improved reliability. As semiconductor processes progress, pattern dimensions, such as line width, and other types of critical dimensions, are continuously shrunken. Such demands require formation of device features with high precision and uniformity, which, in turn, necessitates careful monitoring of the fabrication process, including automated examination of the devices while they are still in the form of semiconductor wafers.

Examination can be provided by using non-destructive examination tools during or after manufacture of the wafer to be examined. Examination generally involves generating certain output (e.g., images, signals, etc.) for a wafer by directing light or electrons to the wafer, and detecting the light or electrons from the wafer. A variety of non-destructive examination tools includes, by way of non-limiting example, scanning electron microscopes, atomic force microscopes, optical inspection tools, etc.

Examination processes can include a plurality of examination steps. The manufacturing process of a semiconductor device can include various procedures such as etching, depositing, planarization, growth such as epitaxial growth, implantation, etc. The examination steps can be performed a multiplicity of times, for example after certain process procedures, and/or after the manufacturing of certain layers, or the like. Additionally, or alternatively, each examination step can be repeated multiple times, for example for different wafer locations, or for the same wafer locations with different examination settings.

Examination processes are used at various steps during semiconductor fabrication for performing e.g. defect related operations. Effectiveness of examination can be improved by automatization of certain process(es) such as, for example, defect detection, Automatic Defect Classification (ADC), Automatic Defect Review (ADR), image segmentation and/or other operations, etc. Automated examination systems ensure that the parts manufactured meet the quality standards expected and provide useful information on adjustments that may be needed to the manufacturing tools, equipment, and/or compositions, depending on the type of errors identified, so as to promote higher yield.

### SUMMARY

In accordance with an aspect of the invention, there is provided a system for layer separation for e-beam overlay metrology, the system comprising
an examination tool configured to:
a) accommodate a wafer that includes an upper layer composed of a first material and a lower layer composed of a second and different material;
the upper layer including a plurality of first patterns and the lower layer includes a plurality of second patterns, wherein at least two of the second patterns are at least partially occluded by at least two of the first patterns;
b) illuminate the wafer with an electron beam (e-beam);
c) detect, by an X-ray detector, a generated X-ray signal, that results from the e-beam striking the wafer; said generated X-ray signal segregating an upper layer signal component and a lower-layer signal component which represent the respective first and second patterns in the upper and lower layers,
wherein the upper layer and lower layer signals are segregated by unique wavelengths that depend on their respective constituent first and second materials;
the system further including a processing and memory circuitry (PMC) associated with the X-ray detector and configured to:
d) obtain or generate a composite X-ray image from said upper layer signal component and said lower layer signal component, wherein the composite X-ray image is representative of respective first patterns in the upper layer and respective second patterns in the lower layer including non-occluded patterns; each non-occluded pattern corresponding to a second pattern in the lower layer that was at least partially occluded in the wafer and is non-occluded in the composite X-ray image.

In addition to the above features, the system according to this aspect of the presently disclosed subject matter can comprise one or more of features (i) to (x) listed below, in any desired combination or permutation which is technically possible:
(i) wherein the PMC is further configured to apply an overlay error calculation to at least the composite X-ray image based on at least one pattern in the upper layer and at least one non-occluded pattern, for determining overlay errors between the upper layer and the lower layer.
(ii) wherein the overlapping error calculation is at least one technique from the group that includes: Center of Gravity (CoG), Center of Edge (CoE), and Center of Distance (COD).
(iii) wherein a first material is SiN (Silicon Nitride) and a second material is Tungsten (W).
(iv) wherein the partially occluded portion of the pattern is an edge of the pattern.
(v) wherein the first pattern is a word (vertical) line and the second pattern is an active area.
(vi) wherein said wafer includes at least n>2 layers, and wherein said upper layer (i) is any of the second layer to the n−1^{th} layer and the lower layer (j) is any of the third layer to the bottom (n^{th}) layer and wherein i<j, and
(vii) wherein the composite X-ray image is representative of patterns in the upper layer and patterns in the lower layer, and wherein the patterns in the upper layer include non-occluded patterns, and patterns in the lower layer include non-occluded patterns,
wherein each non-occluded pattern in the upper layer corresponding to a pattern in the upper layer that was at least partially occluded in the wafer and is non-occluded in the composite X-ray image, and
wherein each non-occluded pattern in the lower layer corresponding to a pattern in the lower layer that was at least partially occluded in the wafer and is non-occluded in the composite X-ray image.
(viii) wherein the wafer includes at least n>2 layers, and wherein the upper layer is the top layer and the lower layer is any of the second layer to the bottom (n^{th}) layer.
(ix) wherein each of said n layers is made of a different material.
(x) wherein the system is further configured to pre-set the illuminated e-beam to an illumination intensity that depends on at least one of the first and second materials and/or their thickness, for achieving penetration depth onto the upper and lower layers, thereby stimulating the interaction of the e-beam with the respective first and second materials, for generating the X-ray signal that is comprised of the upper layer signal component and lower layer signal component.

In accordance with an aspect of the invention, there is provided a computerized system for layer separation for e-beam overlay metrology that includes a processing and memory circuitry (PMC) associated with an X-ray detector and configured to:
generate a composite X-ray image from an upper layer signal component and a lower layer signal component of an X-ray signal that is detected by an X-ray detector and is generated in response to illuminating a wafer with an e-beam,
wherein the wafer includes an upper layer composed of a first material and a lower layer composed of a second and different material; the upper layer including a plurality of first patterns and the lower layer includes a plurality of second patterns, wherein at least two of the second patterns are at least partially occluded by at least two of the first patterns, and
wherein the upper layer signal component and the lower-layer signal component represent the respective first and second patterns in the upper and lower layers; and wherein the upper layer and lower layer signal components are segregable by unique wavelengths that depend on their respective constituent first and second materials, and
wherein the composite X-ray image is representative of respective first patterns in the upper layer and respective second patterns in the lower layer including non-occluded patterns; each non-occluded pattern corresponding to a second pattern in the lower layer that was at least partially occluded in the wafer and is non-occluded in the X-ray image.

This aspect of the disclosed subject matter can comprise one or more of the features (i) to (x) listed above, in any desired combination or permutation which is technically possible.

In accordance with other aspects of the presently disclosed subject matter, there is provided a method for layer separation for e-beam overlay metrology comprising
a) accommodating a wafer that includes an upper layer composed of a first material and a lower layer composed of a second and different material; the upper layer including a plurality of first patterns and the lower layer includes a plurality of second patterns, wherein at least two of the second patterns are at least partially occluded by at least two of the first patterns;
b) illuminating the wafer with an electron beam (e-beam);
c) detecting a generated X-ray signal, that results from the e-beam striking the wafer; said generated X-ray signal segregating an upper layer signal component and a lower-layer signal component which represent the respective first and second patterns in the upper and lower layers,
   wherein the upper layer and lower layer signals are segregated by unique wavelengths that depend on their respective constituent first and second materials;
the method further includes by a processing and memory circuitry (PMC):
d) obtaining or generating a composite X-ray image from said upper layer signal component and said lower layer signal component, wherein the composite X-ray image is representative of respective first patterns in the upper layer and respective second patterns in the lower layer including non-occluded patterns; each non-occluded pattern corresponding to a second pattern in the lower layer that was at least partially occluded in the wafer and is non-occluded in the X-ray image.

This aspect of the disclosed subject matter can comprise one or more of features (i) to (x) listed above with respect to the system, mutatis mutandis, in any desired combination or permutation which is technically possible.

In accordance with other aspects of the presently disclosed subject matter, there is provided a computerized method for layer separation for e-beam overlay metrology that includes a processing and memory circuitry (PMC) associated with an X-ray detector, the method comprising:
generating a composite X-ray image from an upper layer signal component and a lower layer signal component of an X-ray signal that is detected by an X-ray detector and is generated in response to illuminating a wafer with an e-beam,
wherein the wafer includes an upper layer composed of a first material and a lower layer composed of a second and different material; the upper layer including a plurality of first patterns and the lower layer includes a plurality of second patterns, wherein at least two of the second patterns are at least partially occluded by at least two of the first patterns, and
wherein the upper layer signal component and the lower-layer signal component represent the respective first and second patterns in the upper and lower layers; and wherein the upper layer and lower layer signal components are segregable by unique wavelengths that depend on their respective constituent first and second materials, and
wherein the composite X-ray image is representative of respective first patterns in the upper layer and respective second patterns in the lower layer including non-occluded patterns; each non-occluded pattern corresponding to a second pattern in the lower layer that was at least partially occluded in the wafer and is non-occluded in the X-ray image.

This aspect of the disclosed subject matter can comprise one or more of features (i) to (x) listed above with respect to the system, mutatis mutandis, in any desired combination or permutation which is technically possible.

In accordance with other aspects of the presently disclosed subject matter, there is provided a non-transitory computer readable storage medium tangibly embodying a program of instructions that, when executed by a computer, cause the computer to perform a method for layer separation for e-beam overlay metrology comprising:
a) accommodating a wafer that includes an upper layer composed of a first material and a lower layer composed of a second and different material; the upper layer including a plurality of first patterns and the lower layer includes a plurality of second patterns, wherein at least two of the second patterns are at least partially occluded by at least two of the first patterns;
b) illuminating the wafer with an electron beam (e-beam);
c) detecting a generated X-ray signal, that results from the e-beam striking the wafer;
said generated X-ray signal segregating an upper layer signal component and a lower-layer signal component which represent the respective first and second patterns in the upper and lower layers,
wherein the upper layer and lower layer signals are segregated by unique wavelengths that depend on their respective constituent first and second materials; the method further includes by a processing and memory circuitry (PMC):
d) obtaining or generating a composite X-ray image from said upper layer signal component and said lower layer signal component, wherein the composite X-ray image is representative of respective first patterns in the upper layer and respective second patterns in the lower layer including non-occluded patterns; each non-occluded pattern corresponding to a second pattern in the lower layer that was at least partially occluded in the wafer and is non-occluded in the X-ray image.

This aspect of the disclosed subject matter can comprise one or more of features (i) to (x) listed above with respect to the system, mutatis mutandis, in any desired combination or permutation which is technically possible.

In accordance with other aspects of the presently disclosed subject matter, there is provided a non-transitory computer readable storage medium tangibly embodying a program of instructions that, when executed by a computer, cause the computer to perform a method for layer separation for e-beam overlay metrology that includes a processing and memory circuitry (PMC) associated with an X-ray detector, the method comprising:
generating a composite X-ray image from an upper layer signal component and a lower layer signal component of an X-ray signal that is detected by an X-ray detector and is generated in response to illuminating a wafer with an e-beam,
wherein the wafer includes an upper layer composed of a first material and a lower layer composed of a second and different material; the upper layer including a plurality of first patterns and the lower layer includes a plurality of second patterns, wherein at least two of the second patterns are at least partially occluded by at least two of the first patterns, and
wherein the upper layer signal component and the lower-layer signal component represent the respective first and second patterns in the upper and lower layers; and wherein the upper layer and lower layer signal components are segregable by unique wavelengths that depend on their respective constituent first and second materials, and
wherein the composite X-ray image is representative of respective first patterns in the upper layer and respective second patterns in the lower layer including non-occluded patterns; each non-occluded pattern corresponding to a second pattern in the lower layer that was at least partially occluded in the wafer and is non-occluded in the X-ray image.

This aspect of the disclosed subject matter can comprise one or more of features (i) to (x) listed above with respect to the system, mutatis mutandis, in any desired combination or permutation which is technically possible.

### BRIEF DESCRIPTION OF THE DRAWINGS

In order to understand the disclosure and to see how it may be carried out in practice, embodiments will now be described, by way of non-limiting example only, with reference to the accompanying drawings, in which:

FIG. 1 illustrates, schematically, overlay scenarios between word line (vertical lines) and bit line contact (circles);

FIG. 2 illustrates a generalized block diagram of a system for layers' separation, in accordance with certain embodiments of the presently disclosed subject matter;

FIG. 3 illustrates schematically, an electron and X-ray detectors layout, in accordance with certain embodiments of the presently disclosed subject matter;

FIG. 4 illustrates a generalized block diagram of a sequence of operations in a system, in accordance with certain embodiments of the presently disclosed subject matter; and

FIG. 5 illustrates, schematically, an X-ray complementing an SEM image and providing edge information of an occluded underlayer, in accordance with certain embodiments of the presently disclosed subject matter.

### DETAILED DESCRIPTION OF EMBODIMENTS

In semiconductor manufacturing processes, overlay error is a crucial component in the overall error budget. Overlay misalignment (referred to also as “errors”) refers to the degree to which layers of patterns on a semiconductor wafer are out of alignment with each other, which is critical for ensuring the functionality and performance of the integrated circuits. They may also serve for determining known per se Measurement-Based-Inspection (MBI), Distance to shape (CD), and/or possibly other parameters.

As is well known, accurate measurements of OVL (overlay) error are not just metrics of process performance, but are useful means for defect detection, process control, yield management, etc. in semiconductor manufacturing. They enable a deeper understanding of the manufacturing process, leading to more effective interventions and optimizations.

Existing algorithms in e-beam overlay metrology have proven to be robust enough, yet they often under-perform in terms of accuracy. One of the reasons for this is poor signal isolation from underlying layers, in particular where the overlayed patterns partially occlude each other. Higher landing energies and advanced algorithms can help estimate the underlying signal with high accuracy where a part of the underlying edge is visible/not occluded by the top layer.

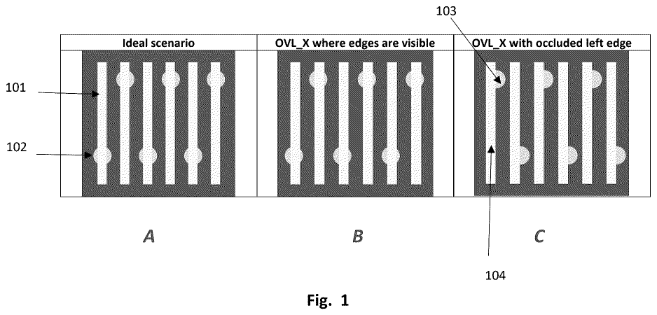

Consider, for example, the overlay scenario denoted as A in FIG. 1, between a top (upper) layer 101 that includes word line (vertical lines) patterns and a bottom (lower) layer 102 that includes partially occluded contact (circles) patterns. In this case, despite using a higher landing energy and higher penetration, the signal separation as received by a known per se electron detector does not suffice to clearly demarcate the edges of the underlying contact layer.

Known image reconstruction algorithms such as, e.g. Center of Gravity (CoG), Center of Edge (CoE), Center of Distance (COD), etc. are likely to fail to deliver accurate overlay error calculation results due to insufficient data for edge reconstruction in the more challenging scenarios of e.g. asymmetric bit line (circles) as shown in the scenario denoted as B in FIG. 1, and even more so in the occluded edge case 103 of FIG. 1, as shown in the scenario denoted as C. These degraded overlay results will be achieved notwithstanding using a higher landing energy and higher penetration. The signal separation does not suffice to clearly demarcate the edges of underlying contact layer.

Note that the specific scenarios of FIG. 1 (shown as A, B, and C, respectively) are provided for illustrative purposes only (for instance, the contact can be of different shape, say ellipsoid or rounded corners rectangle), and, accordingly, the specified degraded overlay error calculation may be even less accurate in the case of layers composed of less structured patterns.

Bearing this in mind, intuitively, in accordance with an aspect of the invention there is provided a system for layer separation for e-beam overlay metrology comprising an examination tool configured to:
a) accommodate a wafer that includes an upper layer composed of a first material and a lower layer composed of a second and different material;
the upper layer including a plurality of first patterns and the lower layer includes a plurality of second patterns, wherein at least two of the second patterns are at least partially occluded by at least two of the first patterns;
b) illuminate the wafer with an electron beam (e-beam);
c) detect, by an X-ray detector, a generated X-ray signal, that results from the e-beam striking the wafer; said generated X-ray signal segregating an upper layer signal component and a lower-layer signal component which represent the respective first and second patterns in the upper and lower layers,
wherein the upper layer and lower layer signals are segregated by unique wavelengths that depend on their respective constituent first and second materials;
the system further including a processing and memory circuitry (PMC) associated with the X-ray detector and configured to:
d) obtain or generate a composite X-ray image from said upper layer signal component and said lower layer signal component, wherein the composite X-ray image is representative of respective first patterns in the upper layer and respective second patterns in the lower layer including non-occluded patterns; each non-occluded pattern corresponding to a second pattern in the lower layer that was at least partially occluded in the wafer and is non-occluded in the composite X-ray image.

Therefore, in accordance with certain embodiments, clear signal separation between the upper and lower layer becomes imperative for accurate overlay error measurement.

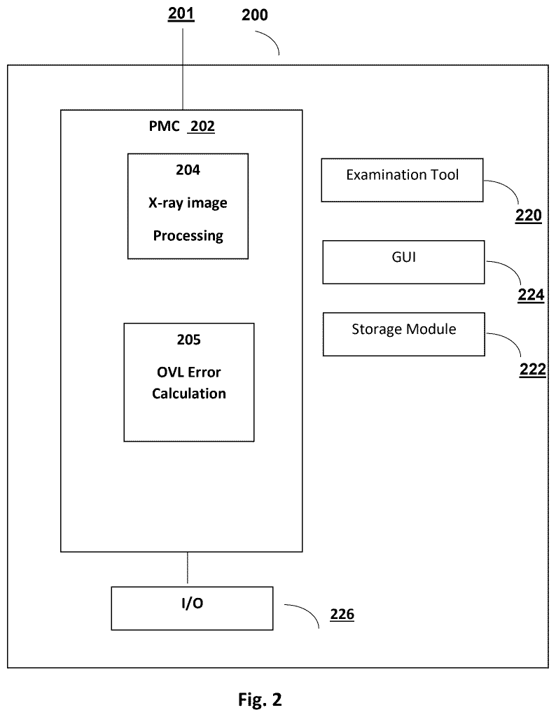

Bearing this in mind, attention is drawn to FIG. 2 illustrating a generalized block diagram of a system for layers' separation in accordance with certain embodiments of the presently disclosed subject matter.

The system 200 illustrated in FIG. 2 can be used for layer separation, enabling calculation of overlay errors for detection of defects in patterns of a semiconductor wafer, all as will be explained in greater detail below.

Without limiting the scope of the disclosure, it should also be noted that the examination tools 220 can be implemented as inspection machines of various types, such as optical inspection machines, electron beam inspection machines (e.g., Scanning Electron Microscope (SEM) [e.g., defect review,], Atomic Force Microscopy (AFM), or Transmission Electron Microscope (TEM), etc.), and so on. In some cases, the same examination tool can provide low-resolution image data and high-resolution image data. The resulting image data (low-resolution image data and/or high-resolution image data) can be transmitted, directly or via one or more intermediate systems, to system 201. The present disclosure is not limited to any specific type of examination tools and/or the resolution of image data resulting from the examination tools.

In some embodiments, at least one of the examination tools 220 can be configured to capture images and perform operations on the captured images.

According to certain embodiments, the examination tool can be an electron beam tool, such as, e.g., a scanning electron microscope (SEM). SEM is a type of electron microscope that produces images of a wafer by scanning the wafer with a focused beam of electrons. The electrons interact with atoms in the wafer, producing various signals that contain information on the surface topography and/or composition of the wafer.

According to certain embodiments of the presently disclosed subject matter, the examination system 200 comprises a computer-based system 201 operatively connected to the examination tools 220 including but not limited to online operation, where images obtained by the examination tool (and in particular an X-ray detector—not shown in FIG. 2) are processed by the various modules of Processing Memory Circuitry (PMC) 202, or, in accordance with other non-limiting embodiments, images obtained by examination tool 220 are received through I/O module 226, and stored in storage module 222 for later off-line processing by PMC 202, all as will be explained in greater detail below.

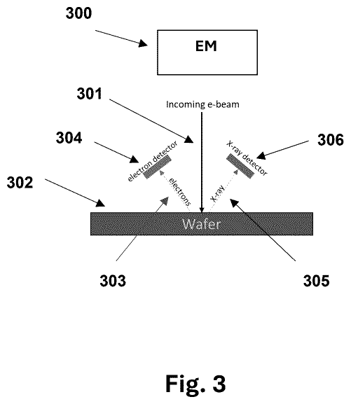

Specifically, system 201 includes a processor and memory circuitry (PMC) 202 operatively connected to a hardware-based I/O interface 226. The PMC 202 is configured to provide processing necessary for operating the system, as further detailed with reference to FIGS. 3 to 5, and comprises one or more processors (not shown separately) operatively connected to a memory (not shown separately). The processor(s) of PMC 202 can be configured to execute several functional modules in accordance with computer-readable instructions implemented on a non-transitory computer-readable memory comprised in the PMC. Such functional modules are referred to hereinafter as comprised in the PMC.

Functional modules comprised in the PMC 202 of system 201 may include, e.g., X-Ray Image Processing module 204, and Overlay Errors Calculation module 205.

The PMC 202 can be configured to obtain, via the I/O interface 226 and from the examination tool 220, data indicative of images that include patterns on semiconductor wafers, which are typically quadrilateral-like with a rounded corners shape, all as will be explained in greater detail below.

Operation of systems 200, 201, 202, and the PMC(s) thereof, as well as the functional modules therein, will be further detailed with reference to FIGS. 3 to 5.

In some cases, additionally to system 201, the examination system 220 can comprise one or more examination modules, such as, e.g., defect detection module and/or Automatic Defect Review Module (ADR), and/or Automatic Defect Classification Module (ADC) and/or other examination modules which are usable for examination of a wafer. The one or more examination modules can be implemented as stand-alone computers, or their functionalities (or at least part thereof) can be integrated with the examination tool 220. In some cases, the output of system 201 such as, e.g., the specified images, can be provided to the one or more examination modules for further processing.

According to certain embodiments, system 201 can comprise a storage module 222. The storage module 222 can be configured to store any data necessary for operating system 201, e.g., data related to input and output of system 201, as well as intermediate processing results generated by system 201. By way of example, the storage module 222 can be configured to store images of the wafer and/or derivatives of X-ray images, processed by the PMC etc. Accordingly, the images can be retrieved from storage module 222 and provided to the PMC 202 for further processing. The output of system 201 can be sent to storage module 222 to be stored. The specified storage module may further store, by way of example, desired probability function, training criterion, training loss value L etc., all as will be explained in greater detail below.

In some embodiments, system 200 can optionally comprise a computer-based Graphical User Interface (GUI) 224 which is configured to enable user-specified inputs related to system 201. For instance, the user can be presented with a visual representation of the wafer (for example, by a display forming part of GUI 124), including image data of the wafer. The user may be provided, through the GUI, with options of defining certain operation parameters. The user can also annotate the reference image via the GUI. The user may also view the operation results on the GUI.

In some cases, system 201 can be further configured to send, via I/O interface 226, the output data to one or more of the examination tools, for further processing. In some cases, system 201 can be further configured to send certain output data to the storage module 222, and/or external systems (e.g., Yield Management System (YMS) of a fabrication plant (FAB)).

Those versed in the art will readily appreciate that the teachings of the presently disclosed subject matter are not bound by the system illustrated in FIG. 2, and in particular not by any of the specified modules 204 and 205, and/or by the operations performed thereby, as described below with reference to FIGS. 3 to 5. Equivalent and/or modified functionality can be consolidated or divided in another manner, and can be implemented in any appropriate combination of software with firmware and/or hardware.

It is noted that the system illustrated in FIG. 2 can be implemented in a distributed computing environment, in which the aforementioned components and functional modules shown in FIG. 2 can be distributed over several local and/or remote devices, and can be linked through a communication network. For instance, the examination tool 220 and the system 201 can be located at the same entity (in some cases hosted by the same device, or distributed over different entities.

It is further noted that in some embodiments at least some of examination tools 220, storage module 222, and/or GUI 224 can be external to the examination system 200 and operate in data communication with systems 200 and 201 via I/O interface 226. System 201 can be implemented as a stand-alone computer(s) to be used in conjunction with the examination tools, and/or with the additional examination modules as described above. Alternatively, the respective functions of the system 201 can, at least partly, be integrated with one or more examination tools 220, thereby facilitating and enhancing the functionalities of the examination tools 220 in examination-related processes.

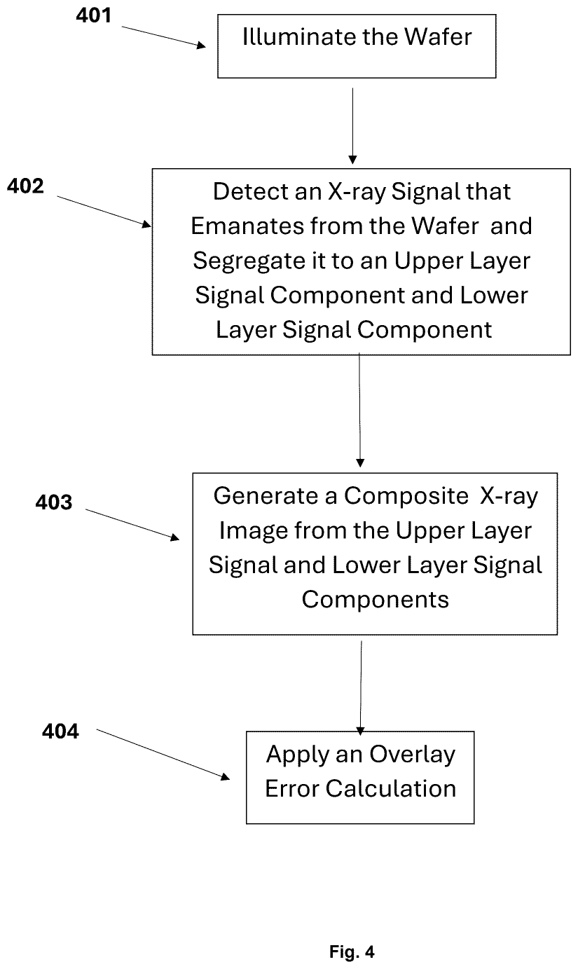

While not necessarily so, the process of operation of systems 201 and 200 can correspond to some or all of the stages of the methods described with respect to FIG. 4. Likewise, the methods described with respect to FIG. 3 and onwards, and their possible implementations, can be implemented by systems 201 and 200, possibly utilizing modules 204 and 205. It is therefore noted that embodiments discussed with respect to FIGS. 3 to 5 can also be implemented, mutatis mutandis, as various embodiments of the systems 201 and 200, and vice versa.

Bearing this in mind, attention is drawn to FIG. 3, illustrating schematically, e-beam and X-ray detectors layout, in accordance with certain embodiments of the presently disclosed subject matter. Thus, and as shown, an EM 300 generates an e-beam 301 that strikes on a wafer 302. The wafer is composed of typically two or more layers, each made of possibly distinct material, such as SiN (Silicon Nitride) or Tungsten (W).

As a result of the impinging electron beam, an electron signal 303 is generated and propagates away from the wafer 302 to be detected by a known per se electron detector 304. In a similar fashion, as a result of the striking e-beam signal 301, an X-ray signal 305 is generated and propagates away from the wafer 302 to be detected by known per se e-X-ray detector 306.

As will be explained in greater detail below, and although not shown in FIG. 3, the generated X-ray signal segregates X-ray signal components (e.g. an upper layer X-ray signal component and a lower layer X-ray signal component), wherein the distinct signal components are segregated by unique wavelengths that depend on the respective materials from which the X-ray signal component is generated. Note that by segregating according to wavelength it encompasses also the equivalents of say frequency or energy.

Note that while in FIG. 3 the detectors are depicted in a spaced apart configuration, and the generated signals are depicted as propagating in different directions, this is only a simplified representation, and, as is generally known per se in certain embodiments, the detectors may be placed at specific angles to capture different signals emitted from the wafer when an electron beam (e-beam) strikes it. In certain embodiments, the electron detector, which captures secondary or backscattered electrons, is positioned at a high angle relative to the wafer, often to the side of the electron beam. This allows it to detect electrons reflected from the surface efficiently. The X-ray detector, used to capture X-ray signals emitted from the sample, may be positioned closer to the wafer and at a lower angle. This ensures better collection of the X-ray signals generated by the interaction between the incident e-beam and the wafer. The invention is of course not bound by specific layout configuration of the detectors, which may vary, depending upon the particular application.

Note also that whereas in FIG. 3 the detectors 304 and 306 are shown as separate modules, in accordance with other embodiments they may form an integral part of the(S) EM machine.

Thus, in accordance with an aspect of the invention, there is provided a system for layer separation for e-beam overlay metrology that includes an examination tool (Electronic Microscope-EM (e.g. SEM or TEM) tool) configured to accommodate a wafer that includes an upper layer composed of a first material (e.g. SiN (Silicon Nitride) and a lower layer composed of a second and different material, e.g. Tungsten (W). Note that the invention is neither bound by utilization of only two layers, nor by the specified materials, and, accordingly, it applies to possibly more layers and/or other materials, mutatis mutandis.

The upper layer includes a plurality of first patterns (see for instance a word [vertical] line 101 in FIG. 1) and the lower layer includes a plurality of second patterns (see for instance, a contact [circle] 103 in FIG. 1), wherein at least a few (say two or more) of the second patterns are at least partially occluded by a few (say, two or more) of the first patterns (see for instance pattern 103 whose edge is partially occluded by pattern 104). Note that the invention is by no means bound by these examples. Other non-limiting examples of patterns may be ellipse contact or rounded corners rectangle contact, or active area, etc.

Bearing this in mind, attention is drawn also to FIG. 4, illustrating a generalized block diagram of a sequence of operations in a system, in accordance with certain embodiments of the presently disclosed subject matter.

At the onset, the EM illuminates the wafer with an electron beam (e-beam) 401. As will be explained in greater detail below, in accordance with certain embodiments, the intensity of the generated e-beam may be set based on at least the type of materials that compose the wafer and/or their thickness, in order to cause sufficient interaction with the materials, and as a result the generated X-ray signal would be at sufficient signal intensity.

Thus, as a result of the interaction of the striking e-beam with the wafer layers, an X-ray signal is generated and is propagated away from the wafer (see e.g. 305 in FIG. 3). The signal is detected (step 402) by a known per se X-ray detector (306). The generated signal that is detected by the detector is segregated into an upper layer signal component and a lower-layer signal component (not shown), which represent the patterns in the upper layer (say e.g. 101 of FIG. 1) and the layers in the lower layer (say e.g. 102 of FIG. 1), respectively. The upper layer and lower layer signals are segregated by their unique wavelength characteristics which depend on the distinct materials that compose the upper and lower layers.

Thus, by way of example, consider Table 1 below (source https://xdb.lbl.gov/Section1/Table_1-2.pdf) showing a few materials and their respective X-ray signal components expressed in energy units (which are convertible to respective wavelengths).

TABLE 1

| | |
|---|---|
| Atomic | Characteristic X-ray lines (keV) |

| number | Element | Kα₁ | Kα₂ | Kβ₁ |
|---|---|---|---|---|
| 22 | Ti | 4.511 | 4.505 | 4.932 |
| 23 | V | 4.952 | 4.944 | 5.427 |
| 24 | Cr | 5.415 | 5.405 | 5.947 |
| 25 | Mn | 5.899 | 5.888 | 6.490 |
| 26 | Fe | 6.404 | 6.391 | 7.058 |
| 27 | Co | 6.930 | 6.915 | 7.649 |
| 28 | Ni | 7.478 | 7.461 | 8.265 |
| 29 | Cu | 8.048 | 8.028 | 8.905 |
| 30 | Zn | 8.639 | 8.616 | 9.572 |

Thus, consider for example Ti (standing for Titanium) with atomic number 22. The emanating X-ray signal component is at an energy of approximately 4510 eV which corresponds to an X-ray wavelength of 0.275 nm, (in accordance with the following known per se conversion formula:

$$λ ( nm ) = \frac{1239.84}{E ( e V )}$$

The same holds true for V (standing for Vanadium) with atomic number 23. The emanated X-ray signal component is at an energy of approximately 4950 eV, which corresponds to an X-ray wavelength of 0.250 nm.

The invention is of course not bound by these particular examples of materials that comprise the wafer layers.

Considering that the X-ray components are adequately segregated by virtue of their respective wavelengths, the detector can detect the distinct signal components.

As further discussed herein, the system further includes a processing and memory circuitry (PMC-see FIG. 2) associated with the X-ray detector. The PMC is configured to generate, by the processor, a composite X-ray image (403) (from the upper layer signal and said lower layer signal.

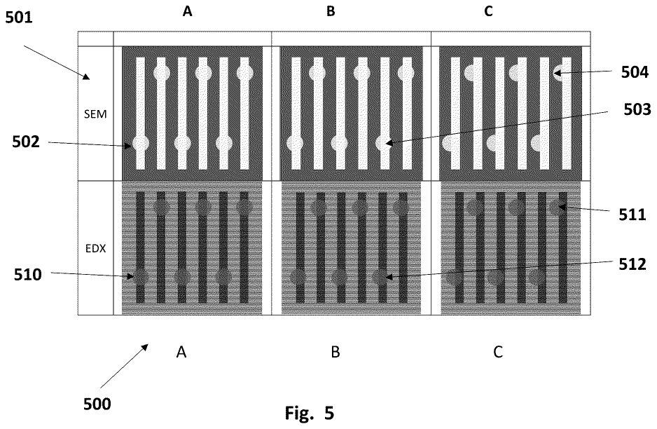

Turning now to FIG. 5, it illustrates an X-ray complementing SEM image 500 as generated by the PMC which, as shown, provides edge information of an occluded underlayer, in accordance with certain embodiments of the presently disclosed subject matter. Thus, turning at first to images 501A-C, they are identical to the images shown in FIG. 1, and include three different scenarios (marked 501A, 501B, and 501C, respectively) of partially occluded patterns (of which only three, namely 502, 503, and 504, are marked) as appearing in an image built based on the signals detected by regular electron detector (e.g. 304 of FIG. 3).

Turning now to images 500A, 500B, and 500C, they include three different scenarios of partially occluded patterns (of which only three, namely 510, 511, and 512, are marked) as appearing in a composite image built based on the signals detected by the X-ray detector (e.g. 306 of FIG. 3). Each non-occluded pattern corresponds to a patten (say 502) in the lower layer that was at least partially occluded (in the electron detector based image 501A, or in other words in the wafer) and is non-occluded (say 510) in the composite X-ray image 500A. Thus, for example, patterns 502, 503, and 504 which are at least partially occluded in images 501A-C, are non-occluded (marked as 510, 511, and 512, respectively) in respective composite X-ray images 500A-C.

Next, in accordance with certain embodiments, as the patterns in both the lower layer and the upper layer of the composite X-ray image are visible, the PMC may apply a known per se overlay error calculation (step 404) to the visible patterns in the upper layer and the visible patterns in the lower layer in order to determine the sought OVL (overlay) error. The overlay error calculation technique may be for instance any of the known Center of Gravity (CoG), Center of Edge (CoE) or Center of distance (COD) technique. Note, however, that the invention is not bound by these particular examples.

In accordance with certain embodiments, the illumination intensity of the e-beam that impinges on the wafer may be pre-set in order to optimize the intensity of the resulting generated X-ray signal. The pre-set illumination intensity (referred to also as “landing energy”, or “energy”) may depend on the type of materials that the impinging e-beam interacts with and/or their respective thickness. Thus, the illumination intensity may depend on the thickness of the material that comprises the wafer in order to guarantee adequate penetration depth of the illuminating e-beam onto the relevant layer, which, in turn, will stimulate interaction with the material that comprises the layer and will entail generation of the resulting X-ray signal component.

A depth vs. landing energy is generally known per se see e.g. “Incidence Energy (KeV)” graph on page 2 of the “Imaging low-dimensional nanostructures by very low voltage scanning electron microscopy: ultra-shallow topography and depth-tunable material contrast” article in “Scientific Reports (2109)” showing the penetration depth of e-beam at different energies for e.g. Silicon (Si) and Gold (Au). The invention is, of course, not bound by these examples.

While the description above exemplifies various embodiments of the invention in the case of a wafer composed of two layers, the invention is by no means bound by this example, and, accordingly, it may be applied to a wafer comprised of three layers or more, mutatis mutandis.

Thus, for the n>2 case, in accordance with certain embodiments, the upper layer is the top layer and the lower layer is any of the second layer to the bottom (n^{th}) layer. In accordance with certain embodiments, while the upper and lower layers are made of different materials, two or more of the n layers are made of identical material, or, in accordance with other embodiments, all of the n layers are made of different materials.

In accordance with certain other embodiments, for the n>2 case, the wafer includes at least n>2 layers, and wherein said upper layer (i) is any of the second layer to the n−1^{th} layer, and the lower layer (j) is any of the third layer to the bottom (n^{th}) layer, and wherein i<j. By this embodiment, the composite X-ray image is representative of patterns in the upper layer and patterns in the lower layer, and wherein the patterns in the upper layer include non-occluded patterns, and patterns in the lower layer include non-occluded patterns. The reason is that, by this embodiment, the upper layer is the second layer or lower, and therefore some of all of its patterns are occluded by at least the top layer. The same holds true for patterns in the lower layer. Thus, by this embodiment, each non-occluded pattern in the upper layer corresponding to a pattern in the upper layer that was at least partially occluded in the wafer (by a pattern in the top layer) and is non-occluded in the composite X-ray image (because, as discussed in detail above, the patterns are visible in the composite X-ray image).

By the same token, each non-occluded pattern in the lower layer corresponding to a pattern in the lower layer that was at least partially occluded in the wafer (by pattern(s) of higher layer(s)) and is non-occluded in the composite X-ray image.

Note that, as described above, each material is characterized by its respective X-ray wavelength, and, accordingly, the X-ray detector should be calibrated to detect the signal components of interest.

For instance, in case the upper and lower layers of interest are the top layer and a middle layer (or one of the middle layers, whichever the case may be), then the X-ray detector may be calibrated to detect signal components at respective wavelengths that correspond to the materials that comprise the top layer and the middle layer (or one of the middle layers). In case the upper and lower layers of interest are the top layer and a bottom layer, then the X-ray detector may be calibrated to detect signal components at respective wavelengths that correspond to the materials that comprise the top and bottom layers, and, in case that the upper and lower layers of interest are the middle layer (or one of the middle layers, whichever the case may be) and the bottom layer, then the X-ray detector may be calibrated to detect signal components at respective wavelengths that correspond to the materials that comprise the middle layer (or one of the middle layers, whichever the case may be) and the bottom layer.

Note that in accordance with a modified embodiment, where two or more of the layers are made of the same material, then the technique in accordance with various embodiments of the invention may be applied to only the layers that are comprised of different materials.

Thus, in a more general manner, the wafer includes at least n>2 layers, and said upper layer (i) being any of the top (first) layer to the n−1^{th} layer, and the lower layer (j) being any of the second layer to the bottom (n^{th}) layer, and wherein i<j. In the specific case of n=3 as exemplified above, the upper later (i) can be any of the layers 1 (top) and 2, and the lower layer may be any of the layers 2 and 3 (bottom), provided that i<j. The latter assumes that each layer is comprised of a different type of material.

Note that whereas the description and claims refer to feeding the output of a computational stage to the next one, the various calculation stages may include known per se interim computational stage(s) that are applied in between the so-described stages.

As discussed above, accurate calculation of OVL errors may be useful for defect detection, including process control, yield management etc., leading to more effective interventions and optimizations.

It is to be noted that examples, equations, and numeral values illustrated in the present disclosure are illustrated merely for exemplary purposes and should not be regarded as limiting the present disclosure in any way. Other appropriate examples/implementations can be used in addition to, or in lieu of the above.

In the detailed description, numerous specific details are set forth in order to provide a thorough understanding of the disclosure. However, it will be understood by those skilled in the art that the presently disclosed subject matter may be practiced without these specific details. In other instances, well-known methods, procedures, components, and circuits have not been described in detail so as not to obscure the presently disclosed subject matter.

Unless specifically stated otherwise, as apparent from the discussions, it is appreciated that, throughout the specification, discussions, utilizing terms such as obtain, fit, determine, or the like, refer to the action(s) and/or process(es) of a computer that manipulate and/or transform data into other data, said data represented as physical, such as electronic, quantities and/or said data representing the physical objects. The term “computer” should be expansively construed to cover any kind of hardware-based electronic device with data processing capabilities as described, e.g., with reference to FIG. 2.

The processor referred to in the current disclosure can represent one or more general-purpose processing devices, such as a microprocessor, a central processing unit, or the like. More particularly, the processor may be a complex instruction set computing (CISC) microprocessor, a reduced instruction set computing (RISC) microprocessor, a very long instruction word (VLIW) microprocessor, a processor implementing other instruction sets, or processors implementing a combination of instruction sets. The processor may also be one or more special-purpose processing devices, such as an application specific integrated circuit (ASIC), a field programmable gate array (FPGA), a digital signal processor (DSP), a network processor, or the like. The processor is configured to execute instructions for performing the operations and steps discussed herein.

The memory referred to herein can comprise a main memory (e.g., read-only memory (ROM), flash memory, dynamic random-access memory (DRAM) such as synchronous DRAM (SDRAM) or Rambus DRAM (RDRAM), etc.), and a static memory (e.g., flash memory, static random-access memory (SRAM), etc.).

The terms “non-transitory memory” and “non-transitory storage medium” used herein should be expansively construed to cover any volatile or non-volatile computer memory suitable to the presently disclosed subject matter. The terms should be taken to include a single medium or multiple media (e.g., a centralized or distributed database, and/or associated caches and servers) that store the one or more sets of instructions. The terms shall also be taken to include any medium that is capable of storing or encoding a set of instructions for execution by the computer and that cause the computer to perform any one or more of the methodologies of the present disclosure. The terms shall accordingly be taken to include, but not be limited to, a read only memory (“ROM”), random access memory (“RAM”), magnetic disk storage media, optical storage media, flash memory devices, etc.

The term “examination” used in this specification should be expansively construed to cover any kind of operations related to defect detection, defect review, and/or defect classification of various types, segmentation, and/or other operations during and/or after the wafer's fabrication process. Examination is provided by using non-destructive examination tools during or after manufacture of the wafer to be examined. By way of non-limiting example, the examination process can include runtime scanning (in a single or in multiple scans), imaging, sampling, detecting, reviewing, measuring (including, e.g., measurements of characteristics of wafer holes and hole's bottom), classifying and/or other operations provided with regard to the wafer or parts thereof, using the same or different inspection tools. Likewise, examination can be provided prior to manufacture of the wafer to be examined, and can include, for example, generating an examination recipe(s) and/or other setup operations. It is noted that, unless specifically stated otherwise, the term “examination”, or its derivatives used in this specification, are not limited with respect to resolution or size of an inspection area. A variety of non-destructive examination tools includes, by way of non-limiting example, scanning electron microscopes (SEM), atomic force microscopes (AFM), optical inspection tools, etc.

The term “examination tool(s)” used herein should be expansively construed to cover any tools that can be used in examination-related processes, including, by way of non-limiting example, scanning (in a single or in multiple scans), imaging, sampling, reviewing, measuring, classifying, and/or other processes provided with regard to the wafer or parts thereof.

It is to be noted that, the term “image(s)” used herein can refer to original images of the wafer captured by the examination tool during the manufacturing process, derivatives of the captured images obtained by various pre-processing stages, and/or computer-generated design data-based images. It is to be noted that in some cases the images referred to herein can include image data (e.g., captured images, processed images, etc.) and associated numeric data (e.g., metadata, hand-crafted attributes, etc.). It is further noted that image data can include data related to one or more layers of interest on the wafer.

It is appreciated that, unless specifically stated otherwise, certain features of the presently disclosed subject matter, which are described in the context of separate embodiments, can also be provided in combination in a single embodiment. Conversely, various features of the presently disclosed subject matter, which are described in the context of a single embodiment, can also be provided separately or in any suitable sub-combination. In the following detailed description, numerous specific details are set forth in order to provide a thorough understanding of the methods and apparatus.

Note that in accordance with certain embodiments, the order of computational stages described herein with reference to the drawings is not necessarily binding. For instance, the order of steps may be changed, steps may be modified or deleted, and/or other steps may be added instead of or in addition to those disclosed herein.

It is to be understood that the present disclosure is not limited in its application to the details set forth in the description contained herein or illustrated in the drawings.

It will also be understood that the system, according to the present disclosure, may be, at least partly, implemented on a suitably programmed computer. Likewise, the present disclosure contemplates a computer program being readable by a computer for executing the method of the present disclosure. The present disclosure further contemplates a non-transitory computer-readable memory tangibly embodying a program of instructions executable by the computer for executing the method of the present disclosure.

The present disclosure is capable of other embodiments and of being practiced and carried out in various ways. Hence, it is to be understood that the phraseology and terminology employed herein are for the purpose of description and should not be regarded as limiting. As such, those skilled in the art will appreciate that the conception upon which this disclosure is based may readily be utilized as a basis for designing other structures, methods, and systems for carrying out the several purposes of the presently disclosed subject matter.

Those skilled in the art will readily appreciate that various modifications and changes can be applied to the embodiments of the present disclosure as hereinbefore described without departing from its scope, defined in and by the appended claims.

1. A system for layer separation for e-beam overlay metrology, the system comprising
an examination tool configured to:
a) accommodate a wafer that includes an upper layer composed of a first material and a lower layer composed of a second and different material;
the upper layer including a plurality of first patterns and the lower layer includes a plurality of second patterns, wherein at least two of the second patterns are at least partially occluded by at least two of the first patterns;
b) illuminate the wafer with an electron beam (e-beam);
c) detect, by an X-ray detector, a generated X-ray signal, that results from the e-beam striking the wafer; said generated X-ray signal segregating an upper layer signal component and a lower-layer signal component which represent the respective first and second patterns in the upper and lower layers,
wherein the upper layer and lower layer signals are segregated by unique wavelengths that depend on their respective constituent first and second materials;
the system further including a processing and memory circuitry (PMC) associated with the X-ray detector and configured to:
d) obtain or generate a composite X-ray image from said upper layer signal component and said lower layer signal component, wherein the composite X-ray image is representative of respective first patterns in the upper layer and respective second patterns in the lower layer including non-occluded patterns; each non-occluded pattern corresponding to a second pattern in the lower layer that was at least partially occluded in the wafer and is non-occluded in the composite X-ray image.

2. The system according to claim 1, wherein said PMC is further configured to apply an overlay error calculation to at least said composite X-ray image based on at least one pattern in the upper layer and at least one non-occluded pattern, for determining overlay errors between the upper layer and the lower layer.

3. The system according to claim 2 wherein said overlapping error calculation is at least one technique from the group that includes: Center of Gravity (CoG), Center of Edge (CoE), and Center of Distance (CoD).

4. The system according to claim 1, wherein a first material is SiN (Silicon Nitride) and a second material is Tungsten (W).

5. The system according to claim 1, wherein the partially occluded portion of the pattern is an edge of the pattern.

6. The system according to claim 1, wherein the first pattern is a word (vertical) line and the second pattern is an active area.

7. The system according to claim 1, wherein said wafer includes at least n>2 layers, and wherein said upper layer (i) is any of the second layer to the n−1^{th} layer and the lower layer (j) is any of the third layer to the bottom (n^{th}) layer and wherein i<j, and
wherein the composite X-ray image is representative of patterns in the upper layer and patterns in the lower layer, and wherein the patterns in the upper layer include non-occluded patterns, and patterns in the lower layer include non-occluded patterns,
wherein each non-occluded pattern in the upper layer corresponding to a pattern in the upper layer that was at least partially occluded in the wafer and is non-occluded in the composite X-ray image, and
wherein each non-occluded pattern in the lower layer corresponding to a pattern in the lower layer that was at least partially occluded in the wafer and is non-occluded in the composite X-ray image.

8. The system according to claim 1, wherein said wafer includes at least n>2 layers, and wherein said upper layer is the top layer and the lower layer is any of the second layer to the bottom (n^{th}) layer.

9. The system according to claim 7, wherein each of said n layers is made of a different material.

10. The system according to claim 8, wherein each of said n layers is made of a different material.

11. The system according to claim 1, wherein said system is further configured to pre-set the illuminated e-beam to an illumination intensity that depends on at least one of said first and second materials and/or their thickness, for achieving penetration depth onto said upper and lower layers, thereby stimulating the interaction of said e-beam with the respective first and second materials, for generating said X-ray signal that is comprised of said upper layer signal component and lower layer signal component.

12. A computerized system for layer separation for e-beam overlay metrology that includes a processing and memory circuitry (PMC) associated with an X-ray detector and configured to:
generate a composite X-ray image from an upper layer signal component and a lower layer signal component of an X-ray signal that is detected by an X-ray detector and is generated in response to illuminating a wafer with an e-beam,
wherein the wafer includes an upper layer composed of a first material and a lower layer composed of a second and different material; the upper layer including a plurality of first patterns and the lower layer includes a plurality of second patterns, wherein at least two of the second patterns are at least partially occluded by at least two of the first patterns, and
wherein the upper layer signal component and the lower-layer signal component represent the respective first and second patterns in the upper and lower layers; and wherein the upper layer and lower layer signal components are segregable by unique wavelengths that depend on their respective constituent first and second materials, and
wherein the composite X-ray image is representative of respective first patterns in the upper layer and respective second patterns in the lower layer including non-occluded patterns; each non-occluded pattern corresponding to a second pattern in the lower layer that was at least partially occluded in the wafer and is non-occluded in the X-ray image.

13. The system according to claim 12, wherein said PMC is further configured to apply an overlay error calculation to at least said X-ray image based on at least one pattern in the upper layer and at least one non-occluded pattern, for determining overlay errors between the upper layer and the lower layer.

14. A method for layer separation for e-beam overlay metrology comprising
a) accommodating a wafer that includes an upper layer composed of a first material and a lower layer composed of a second and different material;
the upper layer including a plurality of first patterns and the lower layer includes a plurality of second patterns, wherein at least two of the second patterns are at least partially occluded by at least two of the first patterns;
b) illuminating the wafer with an electron beam (e-beam);
c) detecting a generated X-ray signal, that results from the e-beam striking the wafer; said generated X-ray signal segregating an upper layer signal component and a lower-layer signal component which represent the respective first and second patterns in the upper and lower layers, wherein the upper layer and lower layer signals are segregated by unique wavelengths that depend on their respective constituent first and second materials;
the method further includes by a processing and memory circuitry (PMC):
d) obtaining or generating a composite X-ray image from said upper layer signal component and said lower layer signal component, wherein the composite X-ray image is representative of respective first patterns in the upper layer and respective second patterns in the lower layer including non-occluded patterns; each non-occluded pattern corresponding to a second pattern in the lower layer that was at least partially occluded in the wafer and is non-occluded in the X-ray image.

15. The method according to claim 14, further comprising: applying an overlay error calculation to at least said composite X-ray image based on at least one pattern in the upper layer and at least one non-occluded pattern, for determining overlay errors between the upper layer and the lower layer.

16. A computerized method for layer separation for e-beam overlay metrology that includes a processing and memory circuitry (PMC) associated with an X-ray detector, the method comprising:
generating a composite X-ray image from an upper layer signal component and a lower layer signal component of an X-ray signal that is detected by an X-ray detector and is generated in response to illuminating a wafer with an e-beam,
wherein the wafer includes an upper layer composed of a first material and a lower layer composed of a second and different material; the upper layer including a plurality of first patterns and the lower layer includes a plurality of second patterns, wherein at least two of the second patterns are at least partially occluded by at least two of the first patterns, and
wherein the upper layer signal component and the lower-layer signal component represent the respective first and second patterns in the upper and lower layers; and wherein the upper layer and lower layer signal components are segregable by unique wavelengths that depend on their respective constituent first and second materials, and
wherein the composite X-ray image is representative of respective first patterns in the upper layer and respective second patterns in the lower layer including non-occluded patterns; each non-occluded pattern corresponding to a second pattern in the lower layer that was at least partially occluded in the wafer and is non-occluded in the X-ray image.

17. The method according to claim 16, further comprising: applying an overlay error calculation to at least said composite X-ray image based on at least one pattern in the upper layer and at least one non-occluded pattern, for determining overlay errors between the upper layer and the lower layer.

18. A non-transitory computer readable storage medium tangibly embodying a program of instructions that, when executed by a computer, cause the computer to perform a method for layer separation for e-beam overlay metrology comprising:
a) accommodating a wafer that includes an upper layer composed of a first material and a lower layer composed of a second and different material;
the upper layer including a plurality of first patterns and the lower layer includes a plurality of second patterns, wherein at least two of the second patterns are at least partially occluded by at least two of the first patterns;
b) illuminating the wafer with an electron beam (e-beam);
c) detecting a generated X-ray signal, that results from the e-beam striking the wafer; said generated X-ray signal segregating an upper layer signal component and a lower-layer signal component which represent the respective first and second patterns in the upper and lower layers, wherein the upper layer and lower layer signals are segregated by unique wavelengths that depend on their respective constituent first and second materials;
the method further includes by a processing and memory circuitry (PMC):
d) obtaining or generating a composite X-ray image from said upper layer signal component and said lower layer signal component, wherein the composite X-ray image is representative of respective first patterns in the upper layer and respective second patterns in the lower layer including non-occluded patterns; each non-occluded pattern corresponding to a second pattern in the lower layer that was at least partially occluded in the wafer and is non-occluded in the X-ray image.

19. The non-transitory computer readable storage medium embodying a program of instructions according to claim 18, that, when executed by a computer, cause the computer to further perform the method step of applying an overlay error calculation to at least said composite X-ray image based on at least one pattern in the upper layer and at least one non-occluded pattern, for determining overlay errors between the upper layer and the lower layer.

20. A non-transitory computer readable storage medium tangibly embodying a program of instructions that, when executed by a computer, cause the computer to perform a method for layer separation for e-beam overlay metrology that includes a processing and memory circuitry (PMC) associated with an X-ray detector, the method comprising:
generating a composite X-ray image from an upper layer signal component and a lower layer signal component of an X-ray signal that is detected by an X-ray detector and is generated in response to illuminating a wafer with an e-beam,
wherein the wafer includes an upper layer composed of a first material and a lower layer composed of a second and different material; the upper layer including a plurality of first patterns and the lower layer includes a plurality of second patterns, wherein at least two of the second patterns are at least partially occluded by at least two of the first patterns, and
wherein the upper layer signal component and the lower-layer signal component represent the respective first and second patterns in the upper and lower layers; and wherein the upper layer and lower layer signal components are segregable by unique wavelengths that depend on their respective constituent first and second materials, and
wherein the composite X-ray image is representative of respective first patterns in the upper layer and respective second patterns in the lower layer including non-occluded patterns; each non-occluded pattern corresponding to a second pattern in the lower layer that was at least partially occluded in the wafer and is non-occluded in the X-ray image.

21. The non-transitory computer readable storage medium embodying a program of instructions according to claim 20, that, when executed by a computer, cause the computer to further perform the method step of applying an overlay error calculation to at least said composite X-ray image based on at least one pattern in the upper layer and at least one non-occluded pattern, for determining overlay errors between the upper layer and the lower layer.
